(19) United States
(12) Patent Application Publication
(10) Pub. No.: US 2007/0057020 A1
(43) Pub. Date: Mar. 15, 2007

(54) FLUX COLLECTION SYSTEM

(75) Inventors: Motomu SHIBAMURA, Tokyo (JP); Toshiyuki Asai, Tokyo (JP); Takayuki Matsuoka, Tokyo (JP); Takayuki Ando, Tokyo (JP); Atsushi Tanaka, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: The Furukawa Electric Co., Ltd., Tokyo (JP)

(21) Appl. No.: 11/468,155

(22) Filed: Aug. 29, 2006

(30) Foreign Application Priority Data
Aug. 30, 2005 (JP) 2005-249328

(51) Int. Cl. A47J 36/02

(52) U.S. Cl. 228/101

(57) ABSTRACT

A flux collection system is proposed in which in a buffering area between an inlet and a heating chamber of a reflow furnace, blowing in-furnace ambient gas to a printed circuit board from a position under a carrier device and sucking ambient gas at a lower section of the carrier device cause a device to prevent outside air from entering and ambient gas from releasing the ambient gas including flux component to be blown out from a narrowing mechanism to collide with a partition plate and promote mixture of solidified flux and liquefied flux to collect flux easily.

### BACKGROUND OF THE INVENTION

1. Technical Field

The present invention relates to a flux collection system for removing a flux component included in inert gas in a reflow furnace in which a printed circuit board mounting electronic components is heated and soldered in inert gas such as nitrogen and the like. Inert gas such as nitrogen and the like is referred to as ambient gas.

2. Related Arts

Recently, SMDs (Surface Mounted Devices) in which various electronic components are mounted on a surface of a printed circuit board and soldered, have been widely used for electronics devices. As a manufacturing method of this SMD, the following two methods have been developed: a flow soldering process in which electronic components are inserted into a printed circuit board and then the back side is dipped and soldered, and a reflow soldering process in which surface-mounted components are mounted on a cream solder printed board and then heated in a heating device calling a reflow furnace to melt cream solder.

A cream solder is a material used when mounting surface-mounted components on a printed circuit board. Solder particles are kneaded with solvent and a catalyzer calling a flux to turn into a material in a creamy manner. A flux included in a cream solder is vaporized and is filled in a furnace when solder is melted. In order to prevent this flux from being liquefied and solidified to be stuck on a printed circuit board as a product or in order to prevent wasted flux from contaminating the environment out of the furnace, flux in the ambient gas is removed by installing a flux collection system.

A reflow furnace is a heating furnace in which while a printed circuit board on which electronic components were mounted is transferred therein through a carrier device composing of a chain conveyor, a printed circuit board and electronic components are soldered by heating such as blowing hot air to melt the solder.

Hereinafter, a heating device for a printed circuit board is referred to as a reflow furnace or simply furnace.

A reflow furnace has two types of furnaces: an atmospheric furnace in which outside air is allowed to enter therein, and a nitrogen reflow furnace in which inert gas such as nitrogen and the like is filled to protect ambient air from entering. The present invention relates to mainly this nitrogen reflow furnace, more particularly a flux collection system in ambient gas used for a system preventing outside air from entering in a furnace inlet and outlet.

The background art relating to a nitrogen reflow furnace according to an embodiment of the present invention is hereinafter described.

First, a configuration of a reflow furnace according to the present invention is described with reference to the drawing (FIG. 11) of the patent document 1 (Japanese Patent Application Publication No. 2001-308512) A reflow furnace 101 is provided with five heating zones 102 and 103 and one cooling zone 104. Number of these heating zones and cooling zones varies depending on a type of a reflow furnace.

The furnace is provided with a rail-interval variable carrying rail (not illustrated), on which a plurality of printed circuit boards are transferred sequentially from the furnace inlet to the furnace outlet in the arrow A direction shown in FIG. 11 on a chain conveyor in the furnace.

The inlet and outlet of the reflow furnace is provided with an air flow-prevention device called a Labyrinth 110 schematically shown in FIG. 11. The Labyrinth comprises a plurality of fin-shaped metal plates and the like, in which the shape of these metal plates generates a swirling current of the air to prevent outside air from entering.

Among the heating zones, first 3 zones are called a preheating zone 102, in which a flux included in cream solder is sufficiently activated. After that, in a peak heating zone 103 in which solder is melted, a printed circuit board is heated to the predetermined temperature. After solder is melted, the printed circuit board is cooled in a cooling zone 104 and then carried out.

As described above, the inlet and outlet of the reflow furnace is provided with an air flow-prevention device called the Labyrinth to prevent outside air from entering the reflow furnace. However, since printed circuit boards being transferred on the carrying rail are in sequence from the inlet, it is difficult to prevent outside air from entering perfectly. Accordingly, designing pressure of ambient gas in the furnace to be higher than outside atmospheric pressure causes gas in the vicinity of the Labyrinth to flow from the inside to the outside of the furnace.

Meanwhile, since nitrogen gas used as ambient gas is included in a cost of manufacturing, it is required that consumption of this nitrogen gas is reduced in order to lower the cost of manufacturing.

In addition, temperature control of the ambient gas in each zone becomes an important element to maintain the quality of the product. Accordingly, it is necessary to prevent outside air from entering and ambient gas from transferring between each zone as a factor as much as possible to disturb temperature control in each zone.

A method for heating a printed circuit board in this reflow furnace is described with reference of FIG. 12. FIG. 12 is a Y-Y line sectional view of FIG. 11. A printed circuit board 106 is transferred on the carrier device 105 in the direction passing through the paper from the front of the paper. The ambient gas in the furnace is sucked from the upper both sides by a circulation fan 108 driven by a fan motor 109 and blown down. During this suction process, the ambient gas is heated by an electric heater 115. The printed circuit board 106 is heated by heated ambient gas and an infrared panel heater 125.

The infrared panel heater 125 is provided under the printed circuit board 106 to heat the bottom side of the printed circuit board at the same time.

Meanwhile, the reflow furnace has an unavoidable problem of collection of flux when designing a device to prevent outside air from entering. Cream solder is used for the printed circuit board. As described above, the cream solder is turned into a material in a creamy manner by kneading solder particles with solvent and a catalyzer calling a flux.

The cream solder of the printed circuit board heated in the heating zone of the reflow furnace is melted and soldering is performed in the furnace. At this time, a flux is vaporized and filled in the furnace. When high-temperature ambient gas containing a flux component comes in contact with outside air, the temperature will decrease, causing flux to be liquefied or solidified. The flux like this is stuck on the printed circuit board, decreasing the quality of the printed circuit board. In addition, the ambient gas containing a flux component is leaked out of the furnace, the environment out of the furnace will be deteriorated. Accordingly, it is necessary to remove the flux in the ambient gas.

Next, the conventional art regarding the flux collection system is described with respect to the drawing (FIG. 13) of the patent document 2 (Japanese Patent Application Publication No. 2003-324272).

FIG. 13 is a sectional view showing a heating chamber of the reflow furnace 101. The printed circuit board 106 is transferred on the carrier device 105 in the direction passing through the paper from the front of the paper. The ambient gas in the furnace marked with the arrow is blown down from a mesh body 151 by the circulation fan 108 driven by the fan motor 109 to heat the printed circuit board 106. The ambient gas which heated the printed circuit board is sucked by the circulation fan 108, is heated by the electric heater 115 and is blown downward again from the both sides.

Meanwhile, some part of the ambient gas blown from the circulation fan 108 is fed to a flux collection system 153 illustrated on the right side of the drawing. The ambient gas cooled by an inside heat exchanger 175 comes in contact with an outside air heat exchanger 163 cooled by an outside air fan 169, causing the flux to be liquefied.

The liquefied flux is collected by a storage tank 173. The ambient gas whose flux component was removed is returned to the heating chamber again and is heated by the electric heater 115.

The above-mentioned flux collection system is only one example and flux collection systems having various configurations have been used actually. However, all types employ the configuration to let ambient gas come in contact with the cooled heat exchanger to liquefy and collect the flux.

In order to prevent a printed circuit board from being deteriorated due to oxidation during soldering work to ensure the high reliability of the printed circuit board, number of users who are desired to solder at low oxygen concentration is growing. However, due to furnace configuration limitations, outside air cannot not be prevented from entering from the inlet or outlet of the furnace. Accordingly, in order to achieve the low oxygen concentration in the furnace, it is necessary to constantly put a plenty of ambient gas into the furnace. However, from a manufacturing cost standpoint, consumption of this ambient gas cannot be neglected. As described above, conventional reflow furnaces have a technical problem in that consumption of nitrogen must be reduced while the predetermined solder melting temperature is achieved at low oxygen concentration.

In addition, according to the conventional arts, flux contained in ambient gas is cooled by a heat exchanger to be liquefied. However, since various components are included in flux, the liquefaction and solidification temperature range is very wide. Accordingly, when flux is liquefied by a heat exchanger, it is possible that some included components are solidified. If solidified flux is stuck on the cooling fin having a narrow interval, flux collection efficiency will be deteriorated. In addition, although it is easy to collect liquefied flux in a flux storage tank to remove, it is difficult to remove the solidified flux.

The patent document 3 (Japanese Patent Application Publication No. 2003-179341) proposes the method to simplify the flux removal by changing a part which solidified flux is stuck on to a detachable type or another patent proposes a collection method by providing a heater to re-melt flux solidified around a heat exchanger.

However, if a detachable configuration is employed, a periodic maintenance work can be simplified but replacement parts must be prepared. In addition, in the method in which a heater is provided to melt the flux, the heating facility is further required. In addition, the conventional system has a problem in that it is necessary to once stop the use of reflow furnace and then melt solidified flux in order to remove the solidified flux.

### BRIEF SUMMARY OF THE INVENTION

Therefore, as a result of various studies and tests conducted by the inventors of the present invention, they invented a system to prevent ambient gas from releasing from the reflow furnace and outside air from entering the reflow furnace, and to simplify removal of flux in ambient gas.

A first embodiment of a flux collection system according to the present invention comprises a suction mechanism to suck ambient gas containing flux in a reflow furnace; a narrowing mechanism to narrow a flow route of said ambient gas; a partition plate with which said ambient gas whose flow route was narrowed collides; and a container for storing a liquefied flux.

It is preferable that, in a second embodiment of a flux collection system according to present invention, the above-mentioned narrowing mechanisms and the partition plates are provided serially in two or more stages.

It is preferable that, in a third embodiment of a flux collection system according to present invention, a cooling fan is provided in the downstream side of the above-mentioned narrowing mechanism and the partition plate or in the middle of each stage.

It is preferable that, in a fourth embodiment of a flux collection system according to present invention, the above-mentioned narrowing mechanism and the partition plate are cooled by a cooling mechanism.

It is preferable that, in a fifth embodiment of a flux collection system according to present invention, a flow route wall further comprising a narrowing mechanism and a partition plate is cooled by a cooling mechanism.

A sixth embodiment of a flux collection system according to present invention comprises a suction mechanism to suck ambient gas containing flux in a reflow furnace; a narrowing mechanism to narrow a flow route for said ambient gas; an expansion mechanism to expand a narrowed ambient gas; and a container for storing a liquefied flux.

It is preferable that, in a seventh embodiment of a flux collection system according to present invention, the narrowing section, the expansion mechanism and the flow route wall for ambient gas are cooled by the cooling mechanism.

It is preferable that, in an eighth embodiment of a flux collection system according to present invention, the above-mentioned cooling mechanism further comprises an outside air fan and a heat exchanger.

In a ninth embodiment of a flux collection system according to present invention, the flux of said ambient gas sucked by a suction device is removed in a reflow furnace having a blowing device to blow said ambient gas from a lower side to an upper side of a carrier device and the suction device for said ambient gas provided in an upper side of said carrier device.

It is preferable that, in a tenth embodiment of a flux collection system according to present invention, the flux of said ambient gas is removed, which is sucked by a suction device provided in a first buffering area between an inlet and a heating chamber of the reflow furnace.

It is preferable that, in a eleventh embodiment of a flux collection system according to present invention, the flux of said ambient gas is removed, which is sucked by a suction device provided in a second buffering area between a heating chamber and a cooling chamber of the reflow furnace.

It is preferable that, in a twelfth embodiment of a flux collection system according to present invention, the flux of said ambient gas is removed, which is sucked by a suction device provided in a third buffering area between an outlet and a cooling chamber of the reflow furnace.

### BRIEF DESCRIPTION OF THE DRAWINGS

The above and other objects and features of the invention will appear more fully hereinafter from a consideration of the following description taken in connection with the accompanying drawing wherein one example is illustrated by way of example, in which;

FIG. 1 is an overall view showing a reflow furnace according to the first embodiment of the present invention;

FIG. 2 is a sectional view showing a reflow furnace at the first buffering area according to the first embodiment of the present invention;

FIG. 3(a) is a view showing a configuration of a suction device for ambient gas according to the embodiments of the present invention, FIG. 3(b) is a sectional view of FIG. 3(a), FIG. 3(c) is a bottom view of FIG. 3(a);

FIG. 4(a) is a view showing a configuration of a flux collection system according to the first embodiment of the present invention, FIG. 4(b) is a sectional view of FIG. 4(a);

FIG. 5(a) is a view showing a configuration of a flux collection system according to the first embodiment of the present invention, FIG. 5(b) is a sectional view of FIG. 5(a);

FIG. 6(a) is a sectional view showing a flux collection system equipped with a narrowing mechanism according to another embodiment of the present invention, FIG. 6(b) and FIG. 6(c) are top views of a narrowing mechanism;

FIG. 7(a) and FIG. 7(b) are views showing other embodiments of a narrowing mechanism and a partition plate;

FIG. 8 is a view showing a configuration of a flux collection system according to the third embodiment of the present invention;

FIG. 9 is an overall view showing configuration of a flux collection system according to the fourth embodiment of the present invention;

FIG. 10 is an overall view showing a reflow furnace according to the fifth embodiment of the present invention;

FIG. 11 is an overall view showing a reflow furnace according to the conventional art;

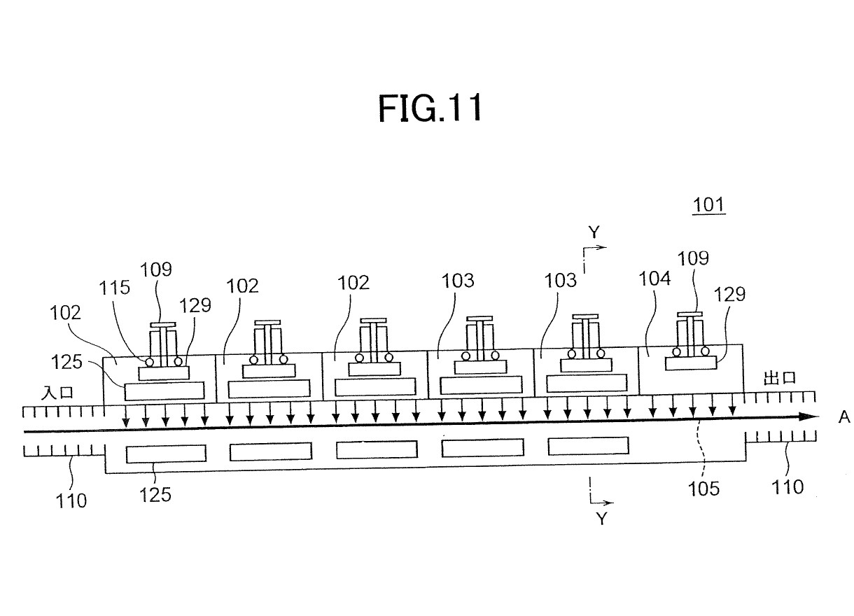

FIG. 12 is a sectional view showing a reflow furnace according to the conventional art; and

FIG. 13 is a view showing a configuration of a flux collection system according to the conventional art.

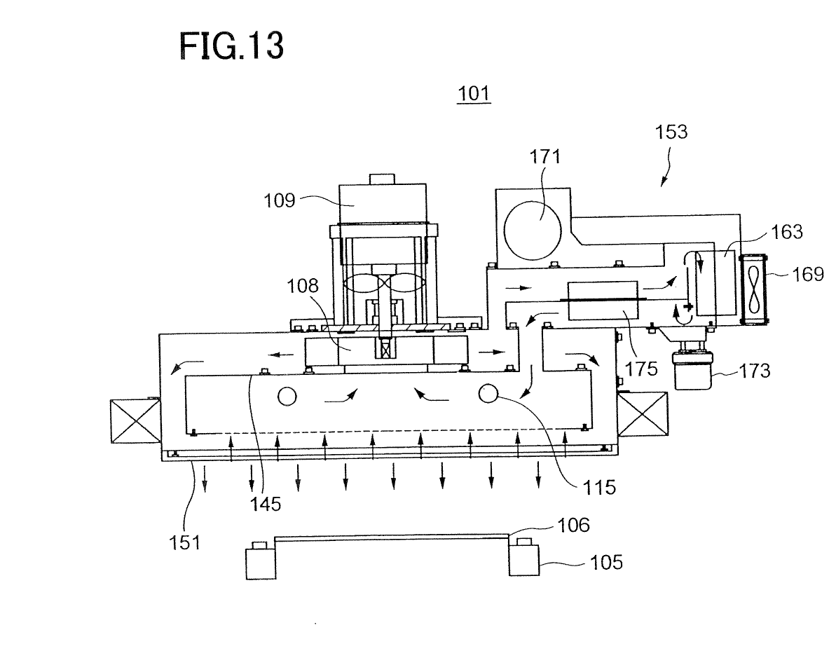

### DETAILED DESCRIPTION OF THE INVENTION

The embodiments of the present invention are described hereinafter in detail with reference to the accompanying drawings.

### First Embodiment

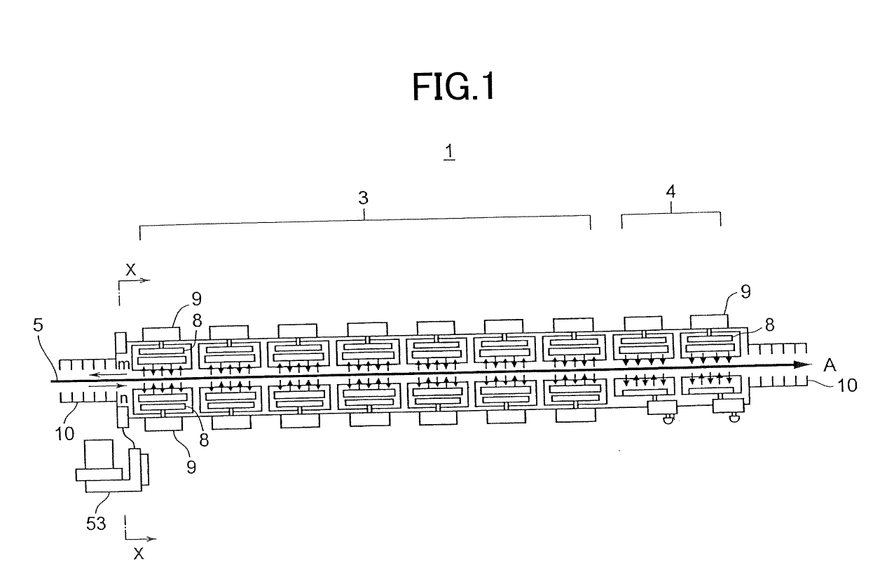

FIG. 1 is an overall view showing an entire configuration of a nitrogen reflow furnace 1 according to the first embodiment of the present invention. A plurality of printed circuit boards (not illustrated) mounted on a carrier device 5 are transferred from an inlet on the left of the drawing toward an outlet on the right side of the drawing in the arrow A direction.

A reflow furnace shown in FIG. 1 is provided with a hearing zone 3 and a cooling zone 4. The heating zone comprises 7 heating chambers and the cooling zone comprises 2 cooling chambers. In this furnace, the first 4 heating chambers are designed to be a preheating zone and the next 3 heating chambers are designed to be a peak heating zone. In these peak heating zones, cream solder on the printed circuit board is melted. After solder is melted, the printed circuit board is transferred to the cooling zone, cooled and then carried out of the furnace.

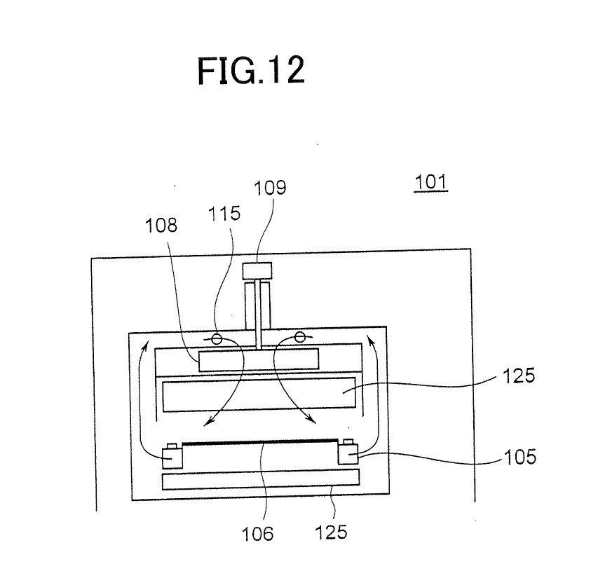

The printed circuit board is heated in each heating chamber based on the heating method described above while referring to FIG. 12. The reflow furnace according to the present invention is provided with the hot air blowing mechanism in the lower side having the same configuration as installed in the upper side of FIG. 12. The above appearance is schematically shown in each heating chamber of FIG. 1.

An inlet and outlet of the reflow furnace are provided with an opening to allow printed circuit boards to enter and exit. Release of ambient gas release and entry of outside air are generated from this opening.

Since releasing ambient gas is heated at 100 or more degree Celsius, it flows and releases on the upper side of the carrier device 5 as shown by the arrow m at the inlet in FIG. 1. Meanwhile, in comparison with the furnace-inside gas, outside air at low temperature flows in the lower side of the carrier device 5 as shown by the arrow n.

Accordingly, in order to prevent outside air from entering, it is effective to block the flow of outside air in the lower side of the carrier device 5 and in order to prevent ambient air from releasing from the furnace, it is effective to block the flow of ambient air in the upper side of the carrier device.

That is, a first buffering area is provided in the boundary between the Labyrinth 10 provided in the inlet and the first heating chamber (hereinafter referred to a preheating chamber) to compose a system to regulate a flow of ambient gas from the lower side to the upper side of the carrier device as serving as an air curtain. Outside air is prevented from entering due to ambient gas blown from the lower side of the carrier device and ambient gas released from the preheating chamber is sucked from the suction device provided on the upper side of the buffering area to prevent it from releasing out of the furnace.

The ambient gas in the furnace includes vaporized flux to be generated when cream solder of the printed circuit board is melted. For this flux, rosin-based flux is liquefied at about 170 degree Celsius and solvent-based flux is liquefied at about 70 degree Celsius. Since outside air enters the buffering area with printed circuit boards, the temperature of the buffering area is lower than the preheating chamber. Accordingly, the temperature of the ambient gas released from the preheating chamber decreases and the liquefaction of flux starts. When sucking the ambient gas at the upper side of the buffering area, it is necessary to prevent flux from being liquefied and dropping onto a printed circuit board.

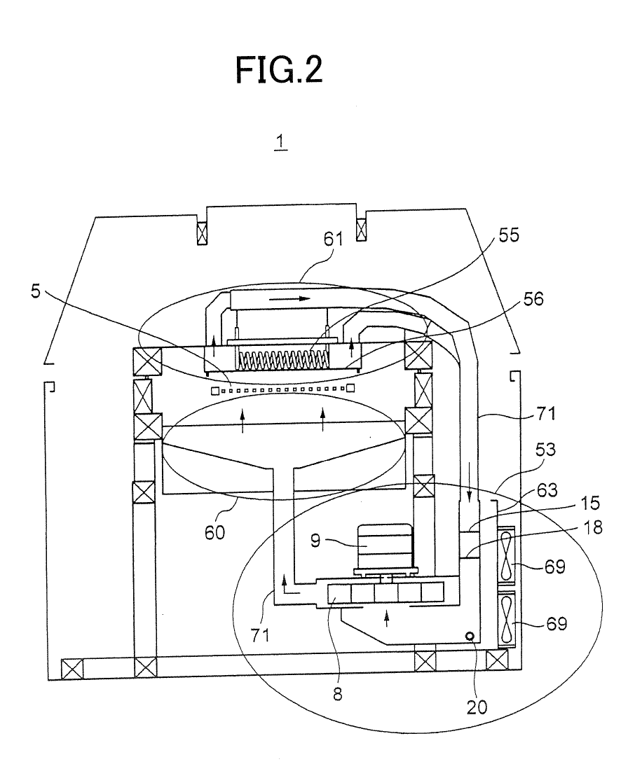

FIG. 2 is a X-X line sectional view of the first buffering area in FIG. 1. The printed circuit board is transferred on the carrier device 5 in the direction passing through the paper from the front of the paper. Ambient gas is blown from a blowing device 60 as shown by an arrow facing upward from the lower side of the carrier device 5 to protect outside air from entering. An ambient gas suction device 61 having a mesh plate 56 and a heating heater 55 is provided above the carrier device 5.

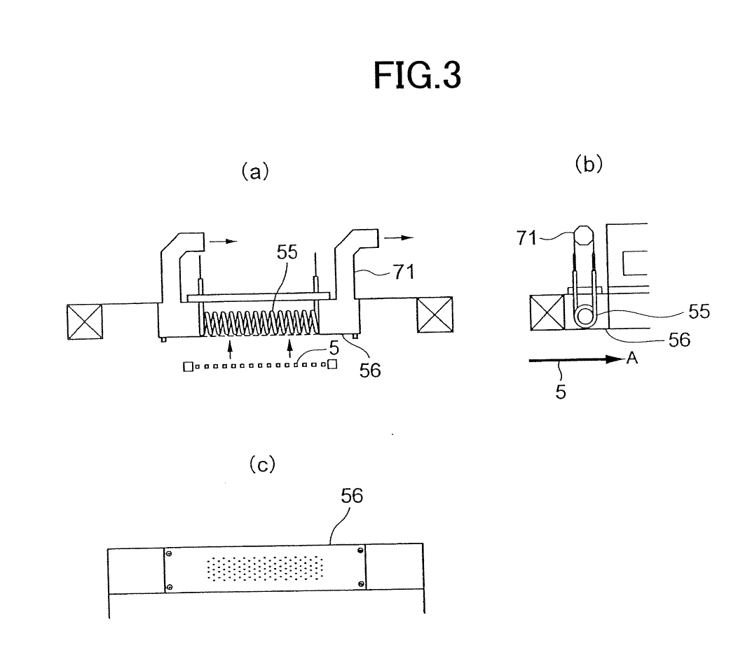

FIG. 3(a) is an enlarged view showing a suction device for ambient gas and a flux dropping-prevention mechanism. As shown by an arrow facing upward from the lower side of the carrier device 5, ambient gas is blown. The ambient gas is sucked by the mesh plate 56 heated by the heating heater 55 to form a vertical air curtain. The sucked ambient gas is introduced into a flux collection system 53 shown in FIG. 1 by a piping 71.

FIG. 3(b) is a side view of this suction device. The printed circuit board is transferred in the arrow A direction by the carrier device 5. FIG. 3(c) is a bottom view of this suction device. This mesh plate 56 is heated by the heating heater 55 and ambient gas is passed through this mesh plate and introduced into the piping 71.

The ambient gas heated by the heating heater 55 shown in FIG. 2 is introduced through the piping 71 and passed through the flux collection system 53, and flux in the ambient gas is liquefied.

The ambient gas whose flux component was removed is fed to the piping 71 by a circulation fan 8 driven by a fan motor 9, and blown out from the lower side of the carrier device 5 by a blowing device 60.

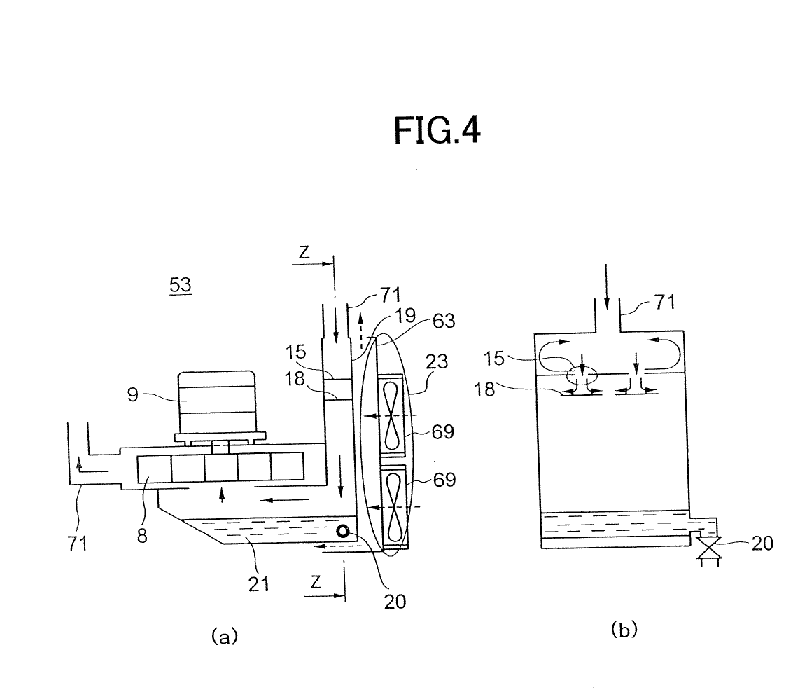

FIG. 4(a) is a sectional view showing the flux collection system 53 according to the present invention. The ambient gas introduced through the piping 71 is introduced into the flux collection system as shown by the arrow, passed through a narrowing mechanism 15 and a partition plate 18 which are described below and is blown out to the piping 71 by the circulation fan 8.

FIG. 4(b) is a Z-Z line sectional view of FIG. 4(a).

The ambient gas introduced by the piping 71 is narrowed by the narrowing mechanism 15 as shown by the arrow. Some part of the ambient gas is returned to the upper section along the inner wall of the system as shown by the arrow to cause convection of ambient gas. In addition, the narrowed ambient gas is passed through the narrowing mechanism and blown out to a wide area, and collides with a partition plate 18 installed directly under.

The ambient gas narrowed by the narrowing mechanism 15 is passed through the narrowing mechanism and expanded, and the temperature decreases. The narrowed ambient gas collides with the partition plate, causing a vortex of the ambient gas in a surrounding area. In addition, the vortex of the ambient gas causes flux stuck on the partition plate, the flow route wall and the like to be peeled off. Meanwhile, the ambient gas also causes flux stuck on the flow route wall and the like to be peeled off. The flux peeled off as described above is absorbed in the ambient gas or liquefied flux in a fine particle manner.

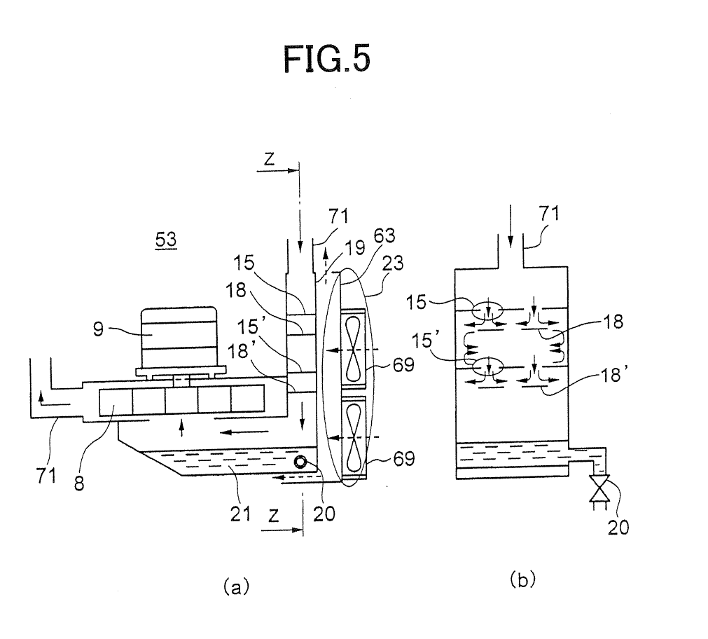

Next, a cooling mechanism 23 is described with respect to FIG. 5. Outdoor air out of the furnace is sucked by an outside air fan 69 as shown by the broken-line arrow in the drawing. According to the present example, 2 outside air fans are installed, however, the number of outside air fans varies depending on a furnace facility.

The outside air sucked from the outside air fan cools the heat exchanger, for example, a heat sink which is not illustrated. The heat sink is connected to the flow route wall 19 comprising the narrowing mechanism 15 and the partition plate 18 thermally to cool the narrowing mechanism, partition plate and flow route wall.

Although the liquefaction temperature varies depending on flux component, flux is in paste form at normal temperature generally and liquefied at about 70 degree Celsius. If further heated, vaporization is remarkable observed at about 170 degree Celsius. The ambient gas which is blown to the printed circuit board in the heating chamber of the reflow furnace reaches about 240 degree Celsius to melt cream solder.

Meanwhile, the flux vaporized in the furnace is liquefied due to decrease in temperature of the ambient gas, however, the liquefaction temperature varies depending on solvent-based or rosin-based flux.

As the temperature of the ambient gas decreases, first the rosin-based flux starts to be liquefied at 180 through 150 degree Celsius. If the temperature of the ambient gas further decreases, the rosin-based flux starts to be solidified at 100 degree Celsius. If further decreases, the solvent-based flux is liquefied at about 70 degree Celsius.

That is, the rosin-based flux is liquefied at about 170 degree Celsius and the solvent-based flux is liquefied at about 70 degree Celsius.

The temperature of the ambient gas in the preheating chamber of the reflow furnace is set at around 170 degree Celsius in many cases. Since the pressure of the ambient gas in the furnace is set to higher than the pressure of outside air, the ambient gas in the preheating gas is flown out to the inlet of the furnace. The component of the solvent-based component of flux and rosin-based component contained in the released ambient gas come in contact with the outside air, resulting in the decrease of the temperature and liquefaction.

The flux collection system according to the present invention has a great effect when ambient gas is used at about temperatures when flux starts to liquefy and solidify.

For example, if the rosin-based material included in the flux is liquefied at 180 through 150 degree Celsius and solidified at 100 degree Celsius, the temperature of the ambient gas discharged from the above-mentioned preheating chamber is about 170 degree Celsius. After this ambient gas is introduced into the flux collection system of the present invention, the rosin-based material starts to be liquefied. The liquefied flux is lowered in the system and stored in a container 21 lowermost installed.

Since the narrowing mechanism 15, the partition plate 18 and the flow route wall 19 are cooled by the thermally-connected heat sink, the temperature of the ambient gas further decreases and liquefaction is promoted. When the temperature of the ambient gas decreases up to around 100 degree Celsius, if the flux includes the above-mentioned flux component, the flux starts to be solidified. The solidified rosin-based flux is stuck on the flow route wall, the partition plate and the like.

However, since the flux is unstable shortly after solidification, the flux comes in contact with the ambient gas at high temperatures and then some part is returned to liquid. The flux shortly after being solidified and stuck is easily peeled off by blown ambient gas. The peeled solidified flux is mixed into the ambient gas in powder form or dissolved into the liquefied flux. The liquefied flux and the solidified flux included in the liquefied flux are stored in the storage container 21 installed in the lower part of the flux collection system. The stored liquefied flux is easily discharged from a valve 20.

### Second Embodiment

A second embodiment of the present invention is described in FIG. 5. The flow route of the ambient gas shown by the arrow introduced through the piping 71 is narrowed by the narrowing mechanism 15 and the narrowed ambient gas collides with the partition plate 18 in the same manner as the first embodiment.

According to the present embodiment, the ambient gas which collided with the partition plate is further narrowed by a second-stage narrowing mechanism 15′ and collides again with the second-stage partition plate 18′. That is, two lines of combination of a narrowing mechanism 15 with the partition plate 18 are serially provided. The ambient gas which collided with the first-stage partition plate 18 collides with the ambient gas which was screened out by the second-stage narrowing mechanism 15′, resulting in generation of vortex. This vortex causes the solidified flux stuck on the narrowing mechanism and the flow route wall to be peeled off.

Since the narrowing mechanism, partition plate and flow route wall are cooled by the cooling mechanism, the second-narrowing mechanism causes the temperature of the ambient gas to decrease further and the liquefaction of the ambient gas to be promoted. According to the temperature of the ambient gas to be introduced by the flux collection system of the present invention, the temperature can be adjusted suitable for liquefaction by installing the multi-stage narrowing mechanism and partition plate.

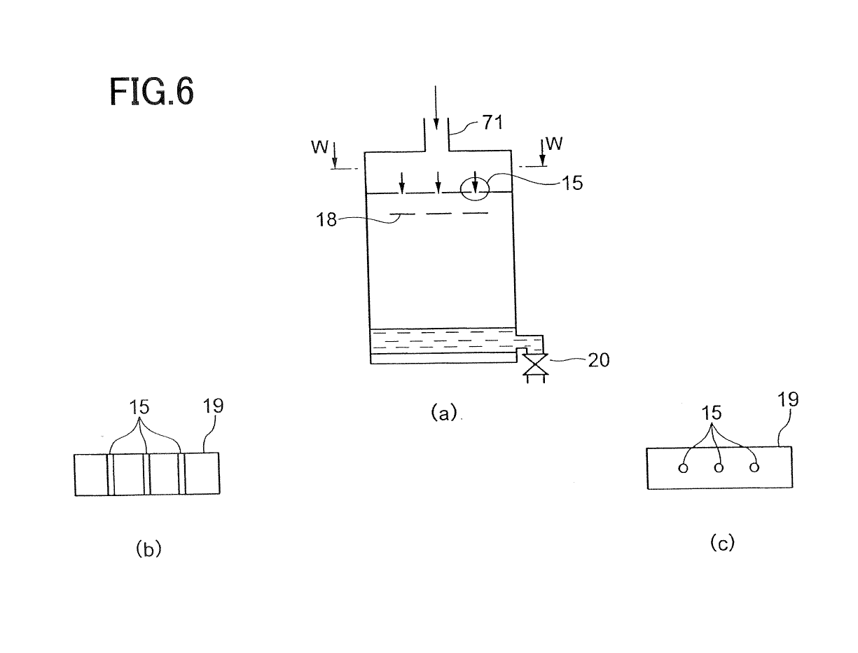

Installation of the narrowing mechanism 15 is not limited to only 2 sections but may be only one section or 3 sections or more as shown in FIG. 4(b) FIG. 6(a) shows another embodiment of the present invention in which the narrowing mechanisms 15 are installed in 3 sections. In addition, as shown in FIG. 6(b), the narrowing mechanism may be composed of semi-rectangular slit as shown in FIG. 6(b) or circular-shaped as shown in FIG. 6(c). In other words, if it is a mechanism narrowing the ambient gas, a suitable one for the system can be employed.

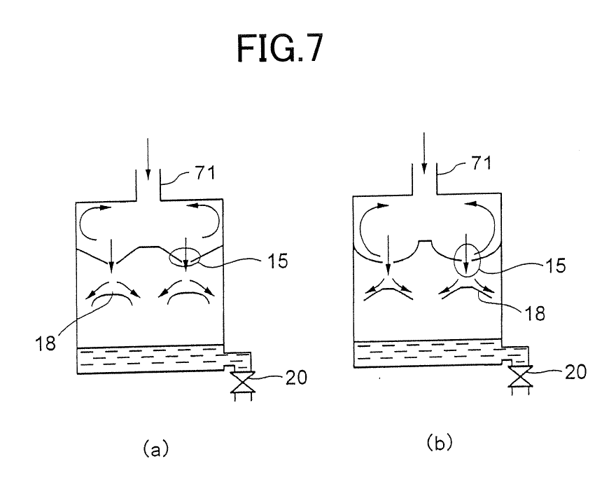

The narrowing mechanism 15 is not limited to a flat configuration as shown in FIG. 4(b) but may be formed in an inclined-surface or curved configuration as shown in FIG. 7(a) and FIG. 7(b).

Also the partition plate 18 may be formed in an inclined-surface or curved configuration. Employing such a configuration makes it easier to let the liquefied flux lower.

Although not illustrated, the configuration shown in FIG. 4(b) in which the partition plate 18 is not installed is also effective for liquefaction of ambient gas. That is, the flow route of the ambient gas shown by the arrow introduced by the piping 71 is narrowed by the narrowing mechanism 15 and then expanded, causing the temperature of the ambient gas to be decreased. This expansion mechanism promotes liquefaction of ambient gas and the liquefied flux is stored in the storage container for liquefied flux installed in low section.

### Third Embodiment

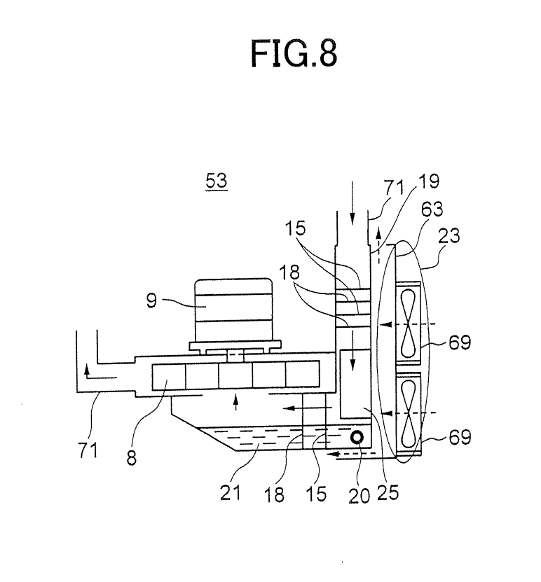

FIG. 8 shows a third embodiment of the present invention. According to the present embodiment, a total of third-stage narrowing mechanism 15 and a partition plate 18 are provided. A cooling fin 25 is provided between the second stage and third stage. The ambient gas is further cooled while it is passed through this cooling fin.

The cooling fin is thermally connected to the heat sink (not illustrated) cooled by the outside air fan 69.

The ambient gas is cooled by the cooling fin 25 and flux included in the ambient gas is further liquefied. According to the present embodiment, the third-stage narrowing mechanism and partition plate are installed vertically and the ambient gas is flown from the right to left as shown by the arrow in the drawing. According to the present embodiment, the third-stage narrowing mechanism and the partition plate are installed vertically, however, they may be installed horizontally in the same manner as the first and second-stage narrowing mechanisms.

According to the embodiment of the flux collection system of the present invention, another cooling mechanism may be installed or the position of the cooling mechanism may be changed. For example, if the temperature of the ambient gas to be introduced into this flux collection system is comparatively high, a method to install a cooling mechanism above the initial-stage narrowing mechanism and introduce the ambient gas into the narrowing mechanism after lowering the temperature of the ambient gas may be employed. Introducing the ambient gas at the most suitable temperature into this flux collection system enables the temperature of the ambient gas to be controlled as the solidified flux and liquefied flux are mixed suitably.

### Fourth Embodiment

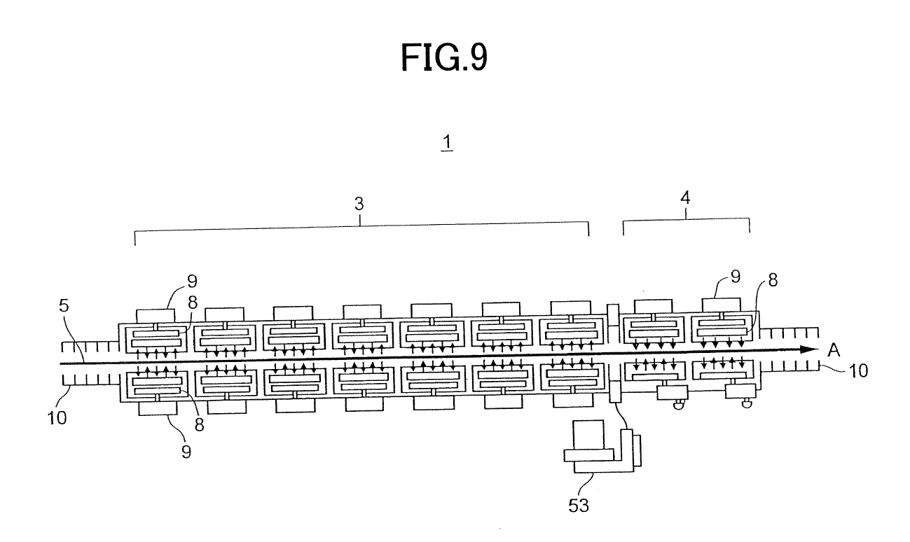

FIG. 9 shows a fourth embodiment of the present invention. The flux collecting system according to the present invention is used for collecting the flux in the ambient gas sucked by the second buffering area installed between the heating chamber and the cooling chamber.

According to present embodiment, the temperature of the ambient gas to be introduced into the flux collection system is around 20 degree Celsius in many cases. It is effective that the ambient gas is introduced into the flux collection system according to the present invention after being cooled by above-mentioned another cooling mechanism.

### Fifth Embodiment

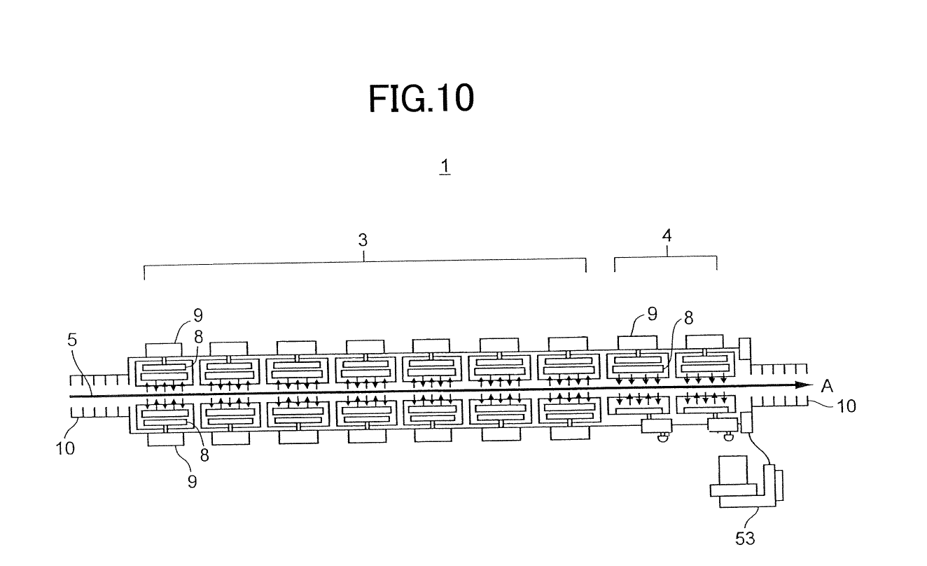

FIG. 10 shows a fifth embodiment of the present invention. The flux collection system according to the present invention is used for collecting the flux in the ambient gas sucked by the third buffering area installed between the cooling chamber and the outlet.

According to the present embodiment, the temperature of the ambient gas to be introduced into the flux collection system is lower than that of the fourth embodiment. Using a heater to heat instead of the cooling mechanism and adjust the temperature of the ambient gas to prevent flux from solidifying in the piping is also effective.

The flux collection system of the present invention is not limited to removal of flux in ambient gas to be sucked in the above-mentioned buffering area but can be used for removal of flux in the ambient gas sucked in the cooling zone.

According to the present invention, in the buffering areas provided respectively in the boundary between the inlet, outlet, heating zone and cooling zone, ambient gas is blown from the lower section to the upper section of the carrier device and is sucked at the upper section of the carrier device, and the flow route of the sucked ambient gas is narrowed by the narrowing mechanism, and the solidified flux is mixed into the liquefied flux by letting the ambient gas whose flow route was narrowed collide with the partition plate and it can be simply collected in the storage section for liquefied flux installed in the lower section of the flow route.

The present invention is not limited to the above described embodiments, and various variations and modifications may be possible without departing from the scope of the present invention.

This application is based on the Japanese Patent application No. 2005-249328 filed on Aug. 30, 2005, entire content of which is expressly incorporated by reference herein.

What is claimed is:

1. A flux collection system comprising:
a suction mechanism to suck ambient gas containing flux in a reflow furnace;
a narrowing mechanism to narrow a flow route of said ambient gas;
a partition plate with which said ambient gas whose flow route was narrowed collides; and
a container for storing a liquefied flux.

2. The flux collection system according to claim 1, wherein said narrowing mechanisms and said partition plates are provided serially in two or more stages.

3. The flux collection system according to claim 2, wherein a cooling fin is provided in a downstream side of said narrowing mechanism and said partition plate or in a middle of each stage.

4. The flux collection system according to claim 1, wherein said narrowing mechanism or said partition plate is cooled by a cooling mechanism.

5. The flux collection system according to claim 1, wherein a wall of the flow route for said ambient gas including said narrowing mechanism or said partition plate is cooled by a cooling mechanism.

6. A flux collection system comprising:
a suction mechanism to suck ambient gas containing flux in a reflow furnace;
a narrowing mechanism to narrow a flow route for said ambient gas;
an expansion mechanism to expand a narrowed ambient gas; and
a container for storing a liquefied flux.

7. The flux collection system according to claim 6, wherein said narrowing mechanism, said expansion mechanism for expanding the ambient gas and the wall of the flow route for the ambient gas are cooled by a cooling mechanism.

8. The flux collection system according to claim 6, wherein said cooling mechanism has an outside air fan and a heat exchanger.

9. The flux collection system according to claim 6, wherein the flux of said ambient gas sucked by a suction device is removed in a reflow furnace having a blowing device to blow said ambient gas from a lower side to an upper side of a carrier device and the suction device for said ambient gas provided in an upper side of said carrier device.

10. The flux collection system according to claim 9, wherein the flux of said ambient gas is removed, which is sucked by a suction device provided in a first buffering area between an inlet and a heating chamber of the reflow furnace.

11. The flux collection system according to claim 9, wherein the flux of said ambient gas is removed, which is sucked by a suction device provided in a second buffering area between a heating chamber and a cooling chamber of the reflow furnace.

12. The flux collection system according to claim 9, wherein the flux of said ambient gas is removed, which is sucked by a suction device provided in a third buffering area between an outlet and a cooling chamber of the reflow furnace.
